(19) United States
(12) Patent Application Publication
(10) Pub. No.: US 2021/0166189 A1
(43) Pub. Date: Jun. 3, 2021

(54) LOGISTICS SYSTEM AND FARE CALCULATION METHOD

(71) Applicant: Sony Corporation, Tokyo (JP)

(72) Inventor: Yasuyuki Kato, Tokyo (JP)

(21) Appl. No.: 17/052,378

(22) PCT Filed: Apr. 15, 2019
(86) PCT No.: PCT/JP2019/016187

§ 371 Date: Nov. 2, 2020

(30) Foreign Application Priority Data
May 9, 2018 (JP) 2018-090358

(51) Int. Cl. G06Q 10/08

(52) U.S. Cl. CPC G06Q 10/087

(57) ABSTRACT

A logistics system according to an embodiment of the present technology includes an information processing apparatus. The information processing apparatus includes a prediction unit and an unloaded space calculation unit. The prediction unit predicts a total loading quantity of the cargo loaded on the moving body that moves between logistics bases. The unloaded space calculation unit calculates an unloaded space capable of loading a cargo of a non-contractor that does not enter into a contract for delivering a cargo with a logistics company that owns the moving body on the basis of the total loading quantity predicted by the prediction unit.

### TECHNICAL FIELD

The present technology relates to a logistics system that predicts a loading quantity of a cargo loaded on a moving body such as a vehicle and predicts an unloaded space of the moving body from the loading quantity, and a fare calculation method of the logistics system.

### BACKGROUND ART

Conventionally, in a logistics industry, it is often carried out to deliver a cargo picked up at an arbitrary logistics base to another logistics base using a moving body such as a truck. At this time, in order to improve a delivery efficiency of the cargo, it is very interesting for those engaged in the logistics industry to take control of a loading state of the cargo loaded on the moving body.

For example, Patent Literature 1 describes a technology of detecting an empty space of a cargo compartment by capturing an image of the cargo compartment of the moving body with a camera, and notifying a delivery base of a space loading rate calculated from the empty space. According to this technology, the moving body loaded with the cargo performs delivery corresponding to an instruction from the delivery base, thereby improving the delivery efficiency.

### CITATION LIST

### Patent Literature

Patent Literature 1: Japanese Patent Application Laid-open No. 2001-334864

### DISCLOSURE OF INVENTION

### Technical Problem

However, the technology described in Patent Literature 1 can only take control of the loading state of the vehicle loaded with the cargo, depending on a delivery state after the cargo is loaded on the vehicle, the moving body may not sufficiently correspond to the instruction from the delivery base. This makes it difficult to effectively utilize the allowable capacity of the moving body even when the moving body loaded with the cargo has the empty space, and to further increase the delivery efficiency.

In view of the above circumstances, an object of the present technology is to provide a logistics system capable of effectively utilizing the allowable capacity of the moving body on which the cargo is loaded and a fare calculation method of the logistics system.

### Solution to Problem

In order to achieve the above object, a logistics system according to an embodiment of the present technology includes an information processing apparatus.

The information processing apparatus includes a prediction unit and an unloaded space calculation unit.

The prediction unit predicts a total loading quantity of the cargo loaded on the moving body that moves between logistics bases.

The unloaded space calculation unit calculates an unloaded space capable of loading a cargo of a non-contractor that does not enter into a contract for delivering a cargo with a logistics company that owns the moving body on the basis of the total loading quantity predicted by the prediction unit.

According to the above configuration, before the cargo is loaded on the moving body, the unloaded space in which the cargo of the non-contractor can be loaded is calculated. Thus, the non-contractor can take control of the loading state of the moving body before loading the cargo, and can load the cargo of the non-contractor on the moving body upon actually loading the cargo. Therefore, it is possible to load the cargo more than the scheduled loading capacity on the moving body, and to effectively utilize the allowable capacity of the moving body.

The information processing apparatus may further include a fare calculation unit that calculates a fare of the cargo loaded on the moving body on the basis of the unloaded space calculated by the unloaded space calculation unit.

Thus, an appropriately priced fare is obtained in response to the predicted unloaded space.

It further includes a detection unit capable of detecting the unloaded space.

The unloaded space calculation unit may calculate the unloaded space on the basis of an output of the detection unit, and the fare calculation unit may calculate the fare of the cargo loaded on the moving body on the basis of the calculated unloaded space.

Thus, an appropriately priced fare is obtained in response to the unloaded space really existed.

The prediction unit may further predict a loading time for loading the cargo on the moving body on the basis of the unloaded space calculated by the unloaded space calculation unit.

Thus, for example, in a case where the moving body is a truck, a driver of the truck takes control of the loading time, the driver can wait until the scheduled amount of the cargo is fully loaded on the truck, and the allowable capacity of the truck can be effectively utilized.

The fare calculation unit may correct the calculated fare in response to a delivery state of the moving body.

Thus, an appropriately priced fare is always obtained in response to the delivery state of the moving body.

The fare calculation unit may correct the fare corresponding to the unloaded space calculated by the unloaded space calculation unit on the basis of at least one of a usage frequency of a logistics route, a type of the cargo loaded on the moving body, or a timing at which a delivery of the cargo is entrusted to the logistics company.

The prediction unit may predict the total loading quantity on the basis of a first loading quantity that is a loading quantity of the cargo that is determined to be loaded on the moving body and a second loading quantity that is a loading quantity of the cargo that is expected to be loaded on the moving body.

Thus, since the total loading quantity is predicted using the loading quantity of the cargo which is determined to be loaded on the moving body, prediction accuracy is improved than directly predicting the total loading quantity from a past trend.

The prediction unit may predict the total loading quantity on the basis of the first loading quantity with respect to a contractor that enters into a contract for delivering the cargo with the logistics company and a second loading quantity with respect to the non-contractor.

This predicts the total loading quantity that takes into account the cargo of the contractor and the cargo of the non-contractor.

It may further include a terminal capable of presenting information about the fare calculated by the fare calculation unit to the non-contractor. Thus, the non-contractor can confirm the fare when entrusting the delivery of the cargo to the logistics company.

In order to achieve the above object, in the fare calculation method according to one embodiment of the present technology, the total loading quantity of the cargo loaded on the moving body moving between logistics bases is predicted.

The unloaded space capable of loading the cargo of the non-contractor that does not enter into the contract for delivering the cargo with the logistics company that owns the moving body on the basis of the total loading quantity predicted.

On the basis of the calculated unloaded space, the fare of the cargo loaded on the moving body is calculated.

### Advantageous Effects of Invention

As described above, according to the present technology, it is possible to provide a logistics system capable of effectively utilizing the allowable capacity of the moving body on which the cargo is loaded and a fare calculation method of the logistics system. Note that the above effects are not necessarily limited, and any of the effects shown in the specification or other effects that can be grasped from the present specification may be achieved together with the above effects or in place of the above effects.

### BRIEF DESCRIPTION OF DRAWINGS

FIG. 1 is a conceptual diagram for explaining a logistics system of the present technology.

FIG. 2 is a schematic diagram schematically showing a configuration example of the logistics system.

FIG. 3 is a block diagram showing a hardware configuration of the information processing apparatus of the present technology.

FIG. 4 is a block diagram showing a configuration example of the logistics system.

FIG. 5 is a flowchart showing a fare calculation method of the logistics system.

FIG. 6 is a conceptual diagram showing steps of predicting a total loading quantity of a cargo to be loaded on a moving body.

FIG. 7 is a conceptual diagram showing steps of calculating a fare of the moving body.

FIG. 8 is a diagram showing an example of a user interface of the present technology.

FIG. 9 is a flowchart showing another fare calculation method of the logistics system.

### MODE(S) FOR CARRYING OUT THE INVENTION

Hereinafter, embodiments of the present technology will be described with reference to the drawings.

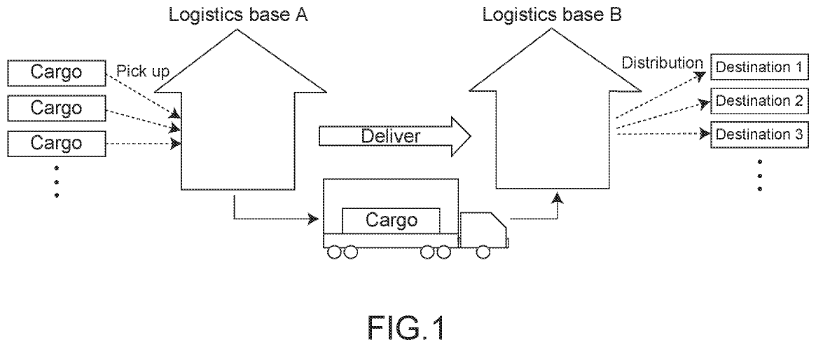

FIG. 1 is a conceptual diagram for explaining a logistics system of the present technology. The present technology applies to a delivery of a cargo from any logistics base A (e.g., logistics terminal) to another logistics base B (e.g., logistics terminal). The cargos of a contractor and a non-contractor are picked-up at the logistics base A, which will be described later.

In the logistics system of the present technology, information is exchanged each other among an information processing apparatus mounted on a moving body, a first terminal handled by the contractor, and a second terminal handled by the non-contractor via a network such as the Internet.

Here, the moving object is a vehicle that loads a cargo picked up at the logistics base A and delivers the cargo to the logistics base B. This vehicle is typically a logistics truck, but is not limited thereto, and is not particularly limited as long as it is a moving body capable of moving between the logistics bases A and B in a state where the cargo is loaded.

The contractor is a shipper that enters into the contract with a logistics company that delivers the cargo from the logistics base A to the logistics base B and has entrusted the delivery of the cargo to the logistics company. Here, the moving body in the present technology is owned by the logistics company entrusted with the delivery of the cargo to the contractor.

The non-contracted contractor does not enter into the contract to deliver the cargo with the logistics company that delivers the cargo from the logistics base A to the logistics base B, and is a third-party shipper unrelated to the logistics company and the contractor. Hereinafter, the logistics system will be described in detail.

<Configuration of Logistics System>

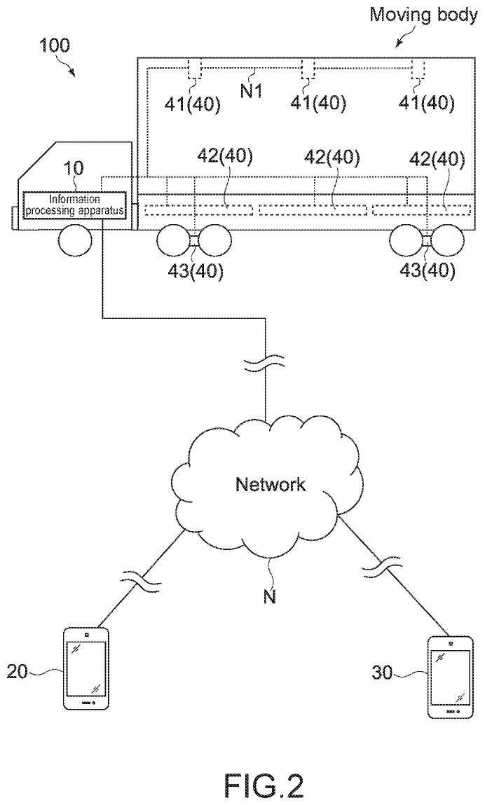

FIG. 2 is a schematic diagram schematically showing a configuration example of a logistics system 100 according to the present embodiment. As shown in FIG. 2, the logistics system 100 includes an information processing apparatus 10, a first terminal 20, a second terminal 30, and a detection unit 40.

In the present embodiment, the information processing apparatus 10, the first terminal 20, and the second terminal 30 are connected capable of communicating with each other via a network N. The network N may be, for example, the Internet, a mobile communication network, a local area network, or the like, and may be a network in which a plurality of types of these networks are combined.

[Information Processing Apparatus]

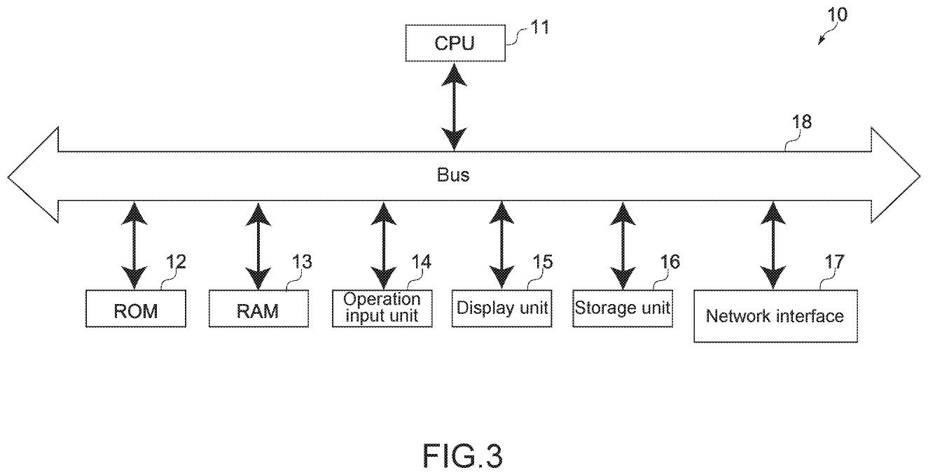

FIG. 3 is a block diagram showing a hardware configuration of the information processing apparatus 10. As shown in FIG. 3, the information processing apparatus 10 includes a CPU 11, a ROM 12, a RAM 13, an operation input unit 14, a display unit 15, a storage unit 16, a network interface 17, and a bus 18.

The CPU 11 loads a program according to the present technology stored in the ROM 12 to the RAM 13 and executes the program. Thus, each block operation of the information processing apparatus 10 is controlled, which will be described later.

The ROM 12 is a memory device that fixedly stores various types of data, programs, and the like used in the information processing apparatus 10.

The RAM 13 is a memory element such as an SRAM (Static Random Access Memory), which is used as a work area for the CPU 11, a temporary storage space for historical data, and the like.

The program is installed in the information processing apparatus 10 via various storage media (internal memory), for example. Alternatively, installing the program may be executed via the Internet, etc.

The operation input unit 14 is an operation device such as a keyboard or a mouse for inputting a user's operation. The operation input unit 14 of the present embodiment may be a touch panel or the like integrally configured with the display unit 15.

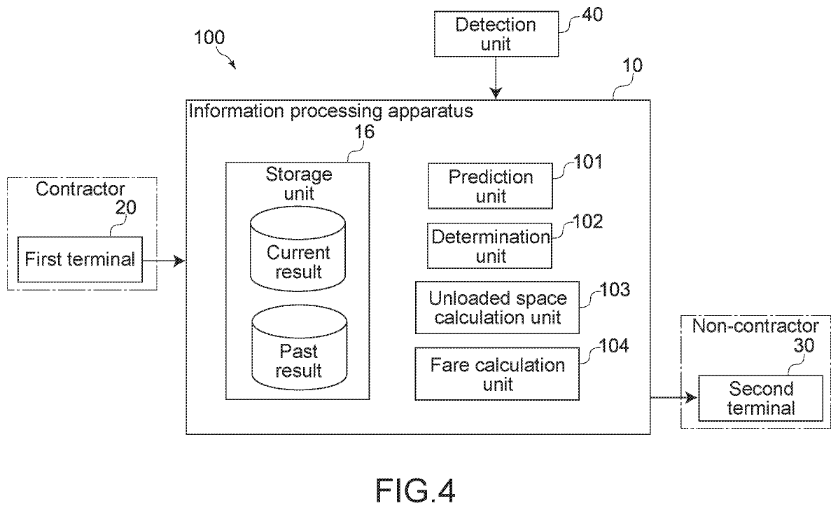

The display unit 15 is, for example, a display device such as a liquid crystal display, an EL display and a plasma display. The storage unit 16 is, for example, a magnetic disk such as an HDD (Hard Disc Drive), a semiconductor memory, an optical disk, or the like. The storage unit 16 of the present embodiment stores a current result and a past result, which will be described later (see FIG. 4).

The network interface 17 is connected to the network N. The bus 18 is a signal transmission path that connects the CPU 11, the ROM 12, the RAM 13, the operation input unit 14, the display unit 15, the storage unit 16, and the network interface 17 to each other.

FIG. 4 is a block diagram showing a configuration example of the logistics system 100 of the present embodiment. The information processing apparatus 10 (CPU 11) functionally includes a prediction unit 101, a determination unit 102, an unloaded space calculation unit 103, and a fare calculation unit 104.

The prediction unit 101 predicts a total loading quantity of the cargo loaded on the moving body moving between the logistics bases A and B. The determination unit 102 determines whether or not a total weight of the cargo loaded on the moving body exceeds a weight limit value. The unloaded space calculation unit 103 calculates the unloaded space in which the cargo of the non-contracted contractor can be loaded on the basis of the total loading quantity predicted by the prediction unit 101.

The fare calculation unit 104 calculates the fare of the cargo loaded on the moving body on the basis of the unloaded space calculated by the unloaded space calculation unit 103.

The information processing apparatus 10 is typically a PC (Personal Computer) or a tablet terminal, but is not limited thereto, and may be any other computer such as a web server and a microcomputer. In addition, the information processing apparatus 10 of the present embodiment is arranged inside the moving body, but is not limited thereto, and may be arranged outside the moving body.

[First Terminal]

The first terminal 20 is handled by the contractor. The first terminal 20 is configured to be capable of receiving information output from the information processing apparatus 10 via the network N and displaying the information. The first terminal 20 is typically a smartphone or a tablet terminal, but is not limited thereto, and may be a computer such as a laptop PC or a desktop PC.

[Second Terminal]

The second terminal 30 is handled by the non-contractor. The second terminal 30 is configured to be capable of receiving information output from the information processing apparatus 10 via the network N and displaying the information.

The second terminal 30 is typically a smartphone or a tablet terminal, but is not limited thereto, and may be a computer such as a laptop PC or a desktop PC. Further, the second terminal 30 may be a device of the same kind as the first terminal 20, or may be a different device.

[Detection Unit]

The detection unit 40 is arranged in a cargo compartment of the moving body, and has a camera 41, a cargo weight meter 42, and a vehicle weight meter 43. The camera 41, the cargo weight meter 42, and the vehicle weight meter 43 are connected to the information processing apparatus 10 via an in-vehicle network N1.

The camera 41 is, for example, a CCD (Charge Coupled Device) camera or a CMOS(Complementary Metal-oxide Semiconductor) camera or the like configured to be capable of capturing an image within the cargo compartment of the moving body. A plurality of the cameras 41 is installed in the moving body so as to be able to capture the image within the entire cargo compartment.

A plurality of the cargo weight meters 42 is arranged on the moving body to measure the weight of the cargo loaded on the moving body. The information processing apparatus 10 calculates the total loading quantity of the cargo loaded on the moving body by summing up measurement results output from the respective cargo weight meters 42. A type of the cargo weight meter 42 is not particularly limited and a gravity measurement system of a strain gauge type, a piezoelectric type or a spring type can be employed, for example.

The vehicle weight meter 43 is an apparatus for measuring a weight of the moving body by measuring an air pressure of a tire. The information processing apparatus 10 calculates a difference between a measurement result (weight) output from the vehicle weight meter 43 and the weight of the moving body itself, thereby calculating the total loading quantity of the cargo loaded on the moving body.

<Fare Calculation Method>

### Applicable Example 1: If there is Time Before Departure

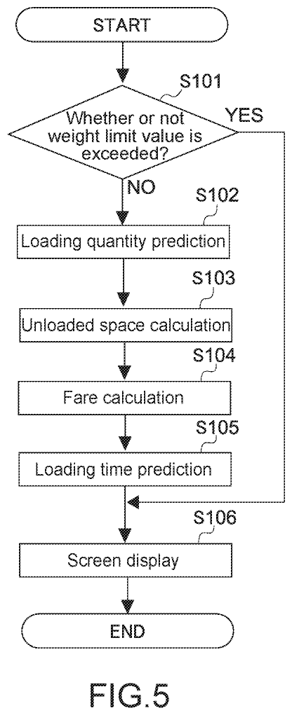

FIG. 5 is a flowchart showing a fare calculation method of the logistics system 100, and shows a flow from a prediction of the total loading quantity to be loaded on the moving body to a presentation of the fare to the non-contractor. Here, in the present embodiment, it is assumed that the cargo of the contractor is loaded on the moving body at the logistics base A, and in a case where the cargo can be further loaded on the moving body loaded with the cargo of the contractor, the cargo of the non-contractor is loaded on the unloaded space of the moving body. Hereinafter, on the basis of this case, if there is a time for the moving body to depart from the logistics base A to the logistics base B, the fare calculation method will be described below with reference to FIG. 5, as appropriate.

(Step S101: Determination of Whether or not Weight Limit Value is Exceeded)

In Step S101, before loading the cargo on the moving body at the logistics base A, it is determined whether or not the total weight of the cargo entrusted by the contractor to the logistics company in advance exceeds the weight limit value. Incidentally, the weight limit value is a limit value defined so as not to exceed a maximum loading weight of the moving body, and is set lower than the maximum loading weight.

Specifically, the determination unit 102 reads out from the storage unit 16 information about the total weight to be loaded on the moving body, which is stored as the current result in the storage unit 16. Next, the determination unit 102 determines whether or not the read total weight exceeds the weight limit value.

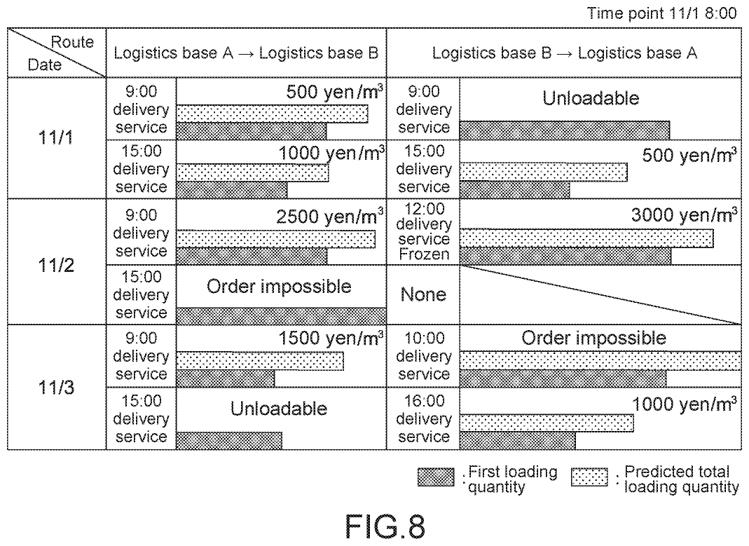

Here, if it is determined by the determination unit 102 that the total weight exceeds the limit value (YES in Step S101), the determination unit 102 notifies the non-contractor via the second terminal 30 that the cargo cannot be loaded on the moving body being “unloadable” or the like (see FIG. 8). On the other hand, if it is determined by the determination unit 102 determines that the total weight does not exceed the weight limit value (NO in Step S101), Step S102, which will be described later, is executed. Incidentally, Step S101 may be omitted as necessary.

(Step S102: Loading Quantity Prediction)

In Step S102, before actually loading the cargo on the moving body at the logistics base A, the total loading quantity of the cargo loaded on the moving body is predicted. Here, the “loading quantity” in the present embodiment is a volume amount (capacity amount) of the cargo occupying a space in the cargo compartment of the moving body, and the same applies to the following description.

First, the prediction unit 101 reads, from the storage unit 16, information about the loading quantity of the cargo for which the contractor has entrusted the delivery to the logistics company in advance, that is, the loading quantity of the cargo for which it has been determined that the cargo is to be loaded on the moving body (first loading quantity). The information is output to the storage unit 16 and the second terminal 30 via the first terminal 20 when the contractor entrusts (orders) the delivery of the cargo to the logistics company, and is stored in the storage unit 16 as the current result.

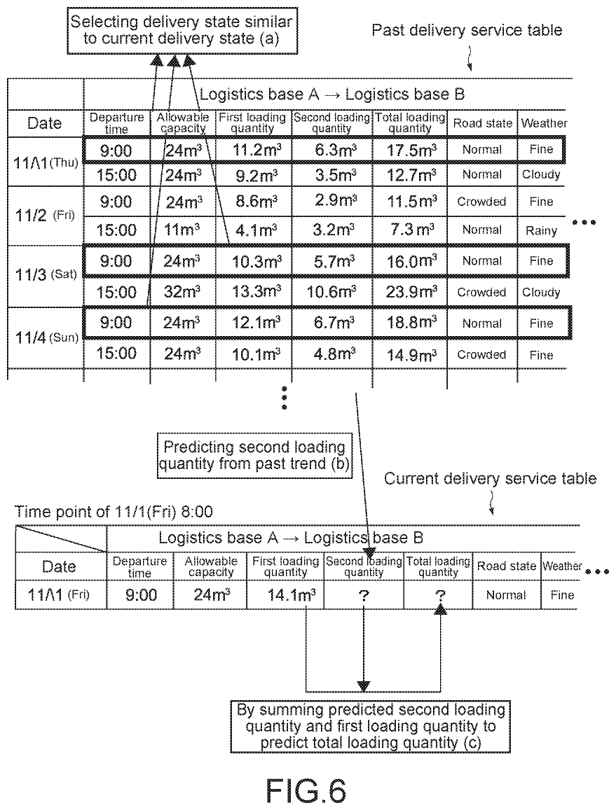

Next, the prediction unit 101 reads out a delivery service table stored in the storage unit 16 as the past result, and by referring to the delivery service table, predicts the loading quantity of the cargo that is expected to be entrusted (ordered) by the non-contractor, that is, the loading quantity (second loading quantity) of the cargo that is expected to be loaded on the moving body. Then, the prediction unit 101 predicts the total loading quantity of the cargo loaded on the moving body from the first and second loading quantities. FIG. 6 is a conceptual diagram showing steps of predicting the total loading quantity of the cargo to be loaded on the moving body.

Specifically, in a case where the cargo is delivered from the logistics base A to the logistics base B, a delivery state similar to the current delivery state is selected from the past delivery service table, and a current second loading quantity is calculated (predicted) on the basis of the second loading quantity relating to the selected delivery state. Here, the “second loading quantity” of the past delivery service table is the loading quantity of the cargo of the non-contractor determined as a result, and is not the expected loading quantity at any time before a departure time.

By explaining taking FIG. 6 as an example, if the current delivery state is “Delivery route: Logistic base A→Logistic base B, Departure time: 9:00, Road state: normal, Weather: fine”, a plurality of delivery states similar to this delivery state from the past delivery service table is selected (FIG. 6a).

Next, as shown in FIG. 6, since the second loading quantities relating to the selected plurality of delivery states are 6.3 m³, 5.7 m³, and 6.7 m³, respectively, a mean value (6.2 m³) is calculated (predicted) as the second loading quantity at a current time (11/1 (Friday) 8:00) (FIG. 6b).

Here, in a case where the second loading quantity is predicted by the above-described method, since the delivery state (road conditions, weather, etc.) varies every moment when the moving body delivers the cargo from the logistics base A to the logistics base B, the predicted second loading quantity varies naturally in real time. In addition to the above, as the delivery state of the moving body, a variation of seasons, days of the week, and the like may be considered, for example.

Subsequently, the prediction unit 101 calculates (predicts) the total loading quantity at the current time point (11/1 (Friday) 8:00) by summing the first loading quantity read from the storage unit 16 and the calculated second loading quantity (FIG. 6c), and outputs the calculation result to the non-loading space calculation unit 103 and the second terminal 30. Incidentally, the predicted total loading quantity varies in real time in response to the variation of the second loading quantity.

It should be noted that the above-mentioned method of predicting the total loading quantity is merely an example, and is not limited to this method, of course. For example, the total loading quantity may be directly predicted (calculated) on the basis of the total loading quantity relating to the selected delivery state by selecting the delivery state similar to the current delivery state from the past delivery service table.

(Step S103: Unloaded Space Calculation)

The unloaded space calculation unit 103 that acquires information about the predicted total loading quantity in previous Step S102 calculates (predicts) the unloaded space on the basis of the loading quantity. Specifically, the unloaded space calculation unit 103 calculates the unloaded space by subtracting the predicted total loading quantity from the allowable capacity of the cargo compartment of the moving body. The calculated information about the unloaded space is output to the prediction unit 101 and the fare calculation unit 104. Incidentally, the allowable capacity is typically an allowable volume of the cargo compartment of the moving body.

Here, if there is no unloaded space (if calculation result is negative or zero), the determination unit 102 notifies the non-contractor that the delivery of the cargo cannot be entrusted (ordered) to the logistics company such as “order impossible” via the second terminal 30 (see FIG. 8).

(Step S104: Fare Calculation)

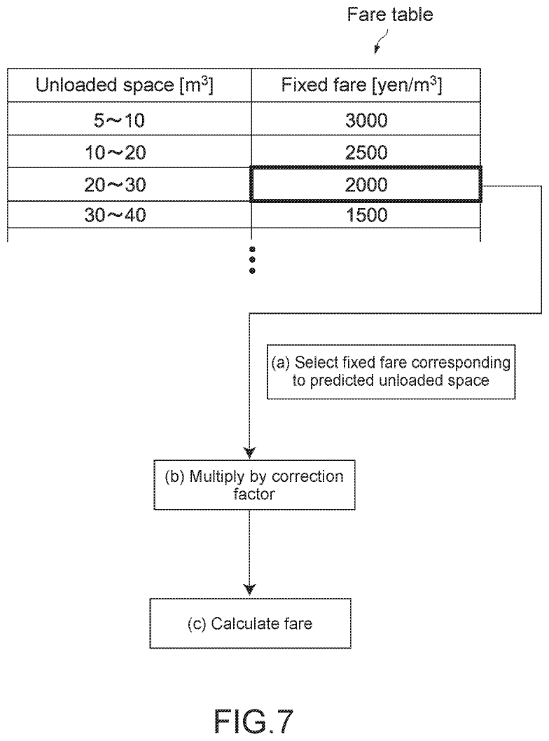

FIG. 7 is a conceptual diagram showing steps of calculating the fare of the moving body on the basis of the predicted unloaded space.

The fare calculation unit 104 that acquires the information about the unloaded space reads out the fare table in which the unloaded space is associated with the fixed fare from the storage unit 16, and selects the fixed fare corresponding to the calculated (predicted) unloaded space from the fare table (FIG. 7a).

Next, the fare calculation unit 104 multiplies the selected fixed fare by a correction factor corresponding to the delivery state at the current time (FIG. 7b), then calculates the fare for delivering the cargo of the non-contractor from the logistics base A to the logistics base B (FIG. 7c), and outputs the information about the fare to the second terminal 30. Incidentally, the calculated fare varies in real time in response to the delivery state of the moving body.

For example, if a usage frequency of the path between the logistics bases A and B is high for the logistics company, a profit of the logistics company may be ensured even if the amount is lower than the fixed fare, and therefore, by multiplying the selected fixed fare by the correction factor corresponding to the usage frequency of the logistics route, the fare of the cargo of the non-contracting company may be lower than the fixed fare.

Alternatively, if the delivered cargo is frozen goods, fragile goods, or the like, a burden on the logistics company delivering such cargo becomes large, and therefore, by multiplying the selected fixed fare by the correction factor corresponding to the type of the cargo loaded on the moving body, the fare of the cargo of the non-contracting company may become higher than the fixed fare.

Alternatively, if the timing at which the non-contractor company entrusts (orders) the delivery of the cargo to the logistics company is immediately before the moving body departs from the logistics base A, there is an advantage to the logistics company, for example, the delivery efficiency in delivering the cargo collected at the logistics base A to another logistics base is improved, and therefore, by multiplying the selected fixed fare by the correction factor corresponding to the timing at which the delivery of the cargo to the moving body (logistics company) is entrusted, the fare of the cargo of the non-contractor may become lower than the fixed fare (for example, last minute fare, etc.).

(Step S105: Loading Time Prediction)

The prediction unit 101, which acquires the information about the unloaded space, reads out the table with which the unloaded space and the loading time are associated from the storage unit 16, and selects the loading time corresponding to the calculated (predicted) unloaded space. Then, the prediction unit 101 outputs the information about the loading time to the display unit 15.

Thus, in a case where the moving body is a truck, the loading time is presented by the driver of the truck, and the driver can wait until the truck is fully loaded with the scheduled amount of the cargo, which makes effective use of the allowable capacity of the truck. Also, the driver can plan an efficient delivery route from the predicted loading time. Incidentally, the above-described loading time is, for example, the loading time when it is assumed that the unloaded space is filled with the predetermined load, and a method of predicting the loading time is not limited to the above.

(Step S106: Screen Display)

FIG. 8 is a diagram showing an example of a user interface displayed on the second terminal 30. The second terminal 30, which acquires the information about the first loading quantity, the total loading quantity, and the fare, displays the information as the user interface as shown in FIG. 8. This allows, for example, the non-contractor to select the delivery service with the lowest fare when entrusting (ordering) the delivery of the cargo to the logistics company.

### Application Example 2: Immediately Before Starting

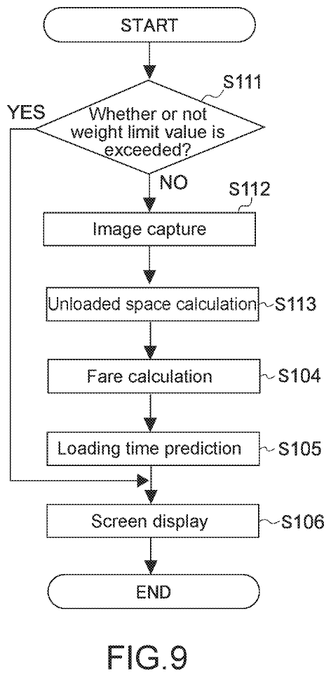

FIG. 9 is a flowchart showing another fare calculation method of the logistics system 100, and is a diagram showing a flow of detecting the unloaded space of the moving body on which the cargo is actually loaded and presenting the fare based on the unloaded space to the non-contractor. Hereinafter, a method of calculating the fare immediately before the moving body departs from the logistics base A will be described with reference to FIG. 9, as appropriate. The same steps as those of the application example 1 are denoted by the same reference numerals, and the description thereof is omitted.

(Step S111: Determination of Whether or not Weight Limit Value is Exceeded)

In Step S111, it is determined whether or not the total weight of the cargo actually loaded on the moving body at the logistics base A exceeds the weight limit value specified in the moving body. Incidentally, the weight limit value is the same as that of the application example 1.

First, a measurement result measured by the cargo weight meter 42 or the vehicle scale 43 is output to the determination unit 102. The determination unit 102 calculates the total weight of the cargo loaded on the moving body from the obtained measurement result (see paragraphs [0045] and [0046] in the present specification), and determines whether or not the calculated total weight exceeds the weight limit value.

Here, if the determination unit 102 determines that the total weight exceeds the weight limit value (YES in Step S111), the determination unit 102 notifies the non-contractor that the cargo cannot be loaded on the moving body such as “unloadable” via the second terminal 30 (see FIG. 8).

On the other hand, if the determination unit 102 determines that the total weight does not exceed the weight limit value (NO in Step S111), Step S112 is executed, which will be described later. Incidentally, Step S111 may be omitted as required.

(Step S112: Image Capture)

Next, the camera 41 captures an image of the cargo compartment of the moving body. Then, image data obtained by this is output to the unloaded space calculation unit 103.

(Step S113: Unloaded Space Calculation)

The unloaded space calculation unit 103 which acquires the image data from the camera 41 calculates the actual unloaded space on the basis of the image data. In this case, a volume (capacity) of a free space of the moving body is typically calculated. Here, if there is no unloaded space, the unloaded space calculation unit 103 notifies the non-contractor that the delivery of the cargo cannot be entrusted (ordered) to the logistics company such as “order impossible” via the second terminal 30 (see FIG. 8). The information about the calculated unloaded space is output to the fare calculation unit 104.

A specific method of analyzing the image data obtained by capturing the image within the cargo compartment of the moving body and calculating an actual empty space (unloaded space) is described in, for example, Japanese Patent Laid-Open No. 2001-334864 (paragraphs [0038] to [0047]).

<Action>

In the logistics system 100, before the cargo is loaded on the moving body, the unloaded space in which the cargo of the non-contractor can be loaded is calculated, and the information about the unloaded space is presented to the non-contractor via the second terminal 30.

As a result, the non-contractor can take control of the loading state of the moving body before loading the cargo, and when the cargo is actually loaded on the moving body, not only the cargo of the contractor but also the cargo of the non-contractor can be loaded on the moving body.

Accordingly, it is possible to load more than the scheduled load quantity of the cargo on the moving body and to effectively utilize the allowable capacity of the moving body. Therefore, the loading rate of the moving body is improved, and the delivery efficiency upon delivering the cargo picked up at the logistics base A to another delivery base is improved.

Further, in the logistics system 100 of the present embodiment, since the total loading quantity is predicted using the loading quantity (first loading quantity) of the cargo that is determined to be loaded on the moving body, the prediction accuracy is improved rather than directly predicting the total loading quantity from the past trend.

Further, in the logistics system 100, since the fixed fare corresponding to the unloaded space is corrected in real time in response to the delivery state on a moment-to-moment basis, the fare properly priced is always presented to the non-contractor.

<Modifications>

Although the embodiments of the present technology have been described above, the present technology is not limited to the embodiments described above, and various modifications may be made.

For example, in the above-described embodiments, a delivery route of the moving object is from the logistics base A at which the cargo is loaded to the logistics base B, but is not limited thereto, and the delivery route may go through one or two or more delivery bases while going from the logistics base A to the logistics base B.

In addition, in the above-described embodiment, the loading quantity of the cargo of the contractor is the first loading quantity, and the loading quantity of the cargo of the non-contractor is the second loading quantity, but it is not limited thereto. The first loading quantity may be the loading quantity of the contractor or the non-contractor as well as both of them, and the same applies to the second loading quantity.

Further, in the above-described embodiment, although the volume of the free space of the moving body is calculated as the unloaded space, but is not limited thereto, and an area of a floor on which the cargo can be placed may be calculated as the unloaded space.

In addition, in the above-described embodiment, the fare is corrected on the basis of the usage frequency of the logistics route, the type of the cargo, or the timing at which the delivery of the cargo is entrusted to the logistics company, but it is not limited thereto, and for example, the fare may be corrected on the basis of the position of the unloaded space in the cargo room of the moving body.

In addition, although the present technology is applied to the delivery of cargo from an arbitrary logistics base to another logistics base, but it is not limited thereto, and an application thereof does not matter.

The present technology may also have the following structures.

(1) A logistics system, including:

an information processing apparatus including
a prediction unit that predicts a total loading quantity of a cargo loaded on a moving body that moves between logistics bases, and
an unloaded space calculation unit that calculates an unloaded space capable of loading a cargo of a non-contractor that does not enter into a contract for delivering the cargo with a logistics company that owns the moving body on the basis of the total loading quantity predicted by the prediction unit.
   (2) The logistics system according to (1), in which

the information processing apparatus further includes a fare calculation unit that calculates a fare of the cargo loaded on the moving body on the basis of the unloaded space calculated by the unloaded space calculation unit.

(3) The logistics system according to (2), further including:

a detection unit capable of detecting the unloaded space, in which

the unloaded space calculation unit calculates the unloaded space on the basis of an output of the detection unit, and

the fare calculation unit calculates the fare of the cargo loaded on the moving body on the basis of the calculated unloaded space.

(4) The logistics system according to any one of (1) to (3), in which

the prediction unit further predicts a loading time for loading the cargo on the moving body on the basis of the unloaded space calculated by the unloaded space calculation unit.

(5) The logistics system according to any one of (2) to (4), in which

the fare calculation unit corrects the calculated fare in response to a delivery state of the moving body.

(6) The logistics system according to (5), in which

the fare calculation unit corrects the fare corresponding to the unloaded space calculated by the unloaded space calculation unit on the basis of at least one of a usage frequency of a logistics route, a type of the cargo loaded on the moving body, or a timing at which a delivery of the cargo is entrusted to the logistics company.

(7) The logistics system according to any one of (1) to (6), in which

the prediction unit predicts the total loading quantity on the basis of a first loading quantity that is a loading quantity of the cargo that is determined to be loaded on the moving body and a second loading quantity that is a loading quantity of the cargo that is expected to be loaded on the moving body.

(8) The logistics system according to (7), in which

the prediction unit predicts the total loading quantity on the basis of the first loading quantity with respect to a contractor that enters into a contract for delivering the cargo with the logistics company and a second loading quantity with respect to the non-contractor.

(9) The logistics system according to any one of (2) to (8), further including:

a terminal capable of presenting information about the fare calculated by the fare calculation unit to the non-contractor.

(10) A fare calculation method, including:

predicting a total loading quantity of a cargo loaded on a moving body moving between logistics bases;

calculating an unloaded space capable of loading a cargo of a non-contractor that does not enter into a contract for delivering a cargo with a logistics company that owns the moving body on the basis of the predicted total loading quantity; and

calculating a fare of the cargo loaded on the moving body on the basis of the calculated unloaded space.

### REFERENCE SIGNS LIST

10 information processing apparatus
20 first terminal
30 second terminal
40 detection unit
100 logistics system
101 prediction unit
102 determination unit
103 unloaded space calculation unit
104 fare calculation unit

1. A logistics system, comprising:
an information processing apparatus including
a prediction unit that predicts a total loading quantity of a cargo loaded on a moving body that moves between logistics bases, and
an unloaded space calculation unit that calculates an unloaded space capable of loading a cargo of a non-contractor that does not enter into a contract for delivering the cargo with a logistics company that owns the moving body on a basis of the total loading quantity predicted by the prediction unit.

2. The logistics system according to claim 1, wherein
the information processing apparatus further includes a fare calculation unit that calculates a fare of the cargo loaded on the moving body on a basis of the unloaded space calculated by the unloaded space calculation unit.

3. The logistics system according to claim 3, further comprising:
a detection unit capable of detecting the unloaded space, wherein
the unloaded space calculation unit calculates the unloaded space on a basis of an output of the detection unit, and
the fare calculation unit calculates the fare of the cargo loaded on the moving body on a basis of the calculated unloaded space.

4. The logistics system according to claim 1, wherein
the prediction unit further predicts a loading time for loading the cargo on the moving body on a basis of the unloaded space calculated by the unloaded space calculation unit.

5. The logistics system according to claim 2, wherein
the fare calculation unit corrects the calculated fare in response to a delivery state of the moving body.

6. The logistics system according to claim 5, wherein
the fare calculation unit corrects the fare corresponding to the unloaded space calculated by the unloaded space calculation unit on a basis of at least one of a usage frequency of a logistics route, a type of the cargo loaded on the moving body, or a timing at which a delivery of the cargo is entrusted to the logistics company.

7. The logistics system according to claim 1, wherein
the prediction unit predicts the total loading quantity on a basis of a first loading quantity that is a loading quantity of the cargo that is determined to be loaded on the moving body and a second loading quantity that is a loading quantity of the cargo that is expected to be loaded on the moving body.

8. The logistics system according to claim 7, wherein
the prediction unit predicts the total loading quantity on a basis of the first loading quantity with respect to a contractor that enters into a contract for delivering the cargo with the logistics company and a second loading quantity with respect to the non-contractor.

9. The logistics system according to claim 2, further comprising:
a terminal capable of presenting information about the fare calculated by the fare calculation unit to the non-contractor.

10. A fare calculation method, comprising:
predicting a total loading quantity of a cargo loaded on a moving body moving between logistics bases;
calculating an unloaded space capable of loading a cargo of a non-contractor that does not enter into a contract for delivering a cargo with a logistics company that owns the moving body on a basis of the predicted total loading quantity; and
calculating a fare of the cargo loaded on the moving body on a basis of the calculated unloaded space.
